(19) United States
(12) Patent Application Publication
(10) Pub. No.: US 2020/0232555 A1
(43) Pub. Date: Jul. 23, 2020

(54) GEAR SHIFTING DEVICE FOR ELECTRIC CARS

(71) Applicant: PINGHU CITY XIAO MING XING CHILDREN'S PRODUCTS CO.,LTD., Jiaxing City (CN)

(72) Inventor: Liping Gu, Pinghu City (CN)

(73) Assignee: PINGHU CITY XIAO MING XING CHILDREN'S PRODUCTS CO.,LTD., Jiaxing City (CN)

(21) Appl. No.: 16/291,466

(22) Filed: Mar. 4, 2019

(30) Foreign Application Priority Data
Jan. 21, 2019 (CN) 2019200936607

(51) Int. Cl. F16H 59/04

(52) U.S. Cl. CPC F16H 59/044; B60Y 2200/81; B60Y 2200/91

(57) ABSTRACT

A gear shifting device for electric cars comprises a shell, a first switch, a second switch and an operating part, wherein a first control button of the first switch and a second control button of the second switch are oppositely arranged, the operating part has an upper portion rotatably connected to the shell and a lower portion provided with an operating rod located between the first control button and the second control button, the first control button is located on a left side of a front-back moving direction of the operating rod, and the second control button is located on a right side of the front-back moving direction of the operating rod. The operating rod is located between the two switches and can move to switch the switches to different positions, and thus, the gear shifting device is ingenious and safe.

### BACKGROUND OF THE INVENTION

### 1. Technical Field

The invention relates to the technical field of electric cars for children, in particular to a gear shifting device for electric cars.

### 2. Description of Related Art

Gear shifting devices of existing electric cars for children are complex in structure, unreliable in control over switches, prone to damage, difficult to assemble and maintain and inconvenient to use and have too many parts. In the prior art, the control buttons of the switches are arranged upwards, and water infiltrating into the shell directly falls onto the control buttons and then directly enters the switches via gaps between the control buttons and the switches under the gravity effect, thereby affecting the circuits in the switches and resulting in potential safety hazards of the electric cars in use.

### BRIEF SUMMARY OF THE INVENTION

The invention provides a gear shifting device which is used for electric cars and is simple and ingenious in structure and capable of effectively solving the technical problems mentioned in the description of related art.

The invention is implemented through the following technical solution:

A gear shifting device for electric cars comprises a shell, a first switch, a second switch and an operating part. A first control button of the first switch and a second control button of the second switch are oppositely arranged. An upper portion of the operating part is rotatably connected to the shell. An operating rod is arranged on a lower portion of the operating part. The operating rod is located between the first control button and the second control button and is able to move back and forth in a front-back direction. The first control button is located on the left side of the front-back moving direction of the operating rod, and the second control button is located on the right side of the front-back moving direction of the operating rod. The operating rod is able to contact the first control button so as to switch the first control button to a first position or a second position and is also able to contact the second control button so as to switch the second control button to a first position or a second position.

The operating rod is located between the control buttons of the two switches and can be moved to switch the control buttons of the switches to different positions efficiently, rapidly, easily and reliably, and the service life is prolonged. In addition, the control buttons are arranged face to face instead of being arranged upwards so that water cannot directly fall into the control buttons, and the whole switches are protected.

The operating rod acts on the first control button of the first switch or acts on the second control button of the second switch in the moving process.

If the first switch is located at a rear left position and the second switch is located at a front right position, the first control button of the first switch serves as a high-low speed switching button, the first position of the first control button is a high-speed gear position, the second position of the first control button is a low-speed gear position, the first position of the second control button is a forward-gear position, and the second position of the second control button is a reverse-gear position; when the operating rod is used for switching the first control button, the second control button is located at the first position; and when the operating rod is used for switching the second control button, the first control button is located at the second position. In this way, it is ensured that electric cars reverse at a low-speed gear, and the safety performance is improved.

If the first switch is located at a front left position and the second switch is located at a rear right position, the second control button serves as a high-low speed switching button and is used for switching between a high speed and a low speed; the first position of the second control button is a high-speed gear position, and the second position of the second control button is a low-speed gear position; and the first control button is used for switching between advancing and reversing, the first position of the first control button is a forward-gear position, and the second position of the first control button is a reverse-gear position.

Furthermore, connecting columns to be rotatably connected to the shell are arranged on two sides of the upper portion of the operating part. The connecting columns on the operating part facilitate rotatable installation of the operating part, namely, the operating part can rotate relative to the center axes of the connecting columns.

Furthermore, the operating rod is provided with first reinforcing plates which protrude forwards, backwards, leftwards and rightwards, and the first reinforcing plates are connected through second reinforcing plates. The first reinforcing plates can improve the strength of the operating rod, can contact the control buttons and can reduce wear of the operating rod so that the control buttons can be reliably controlled for a long time.

Furthermore, a connecting rod is connected to the upper portion of the operating part, an upper end of the connecting rod stretches out of the shell and is connected with a handle, and a first through hole allowing the connecting rod to move forwards or backward is formed in the shell. The connecting rod and the handle facilitate operation of the operating part. The connecting rod can smoothly move through the first through hole.

Furthermore, a sliding plate is disposed around the connecting rod, an upper surface of the sliding plate is an arc-shaped curved surface, a convex part which protrudes upwards is disposed in the middle of the shell, an inner surface of the convex part is an arc-shaped curved surface, and the upper surface of the sliding plate abuts against the inner surface of the convex part. On the one hand, the sliding plate facilitate stable rotation of the connecting rod and the operating part and can maintain the connecting rod and the operating parts at desired positions when the connecting rod and the operating part rotate in position; and on the other hand, the sliding plate can seal the first through hole to prevent dust and impurities from entering the shell from the outside, which may otherwise affect the whole device.

Furthermore, the sliding plate is provided with a first extension part extending in the front-back direction and a second extension part extending in the left-right direction, guide holes or guide columns are arranged on two sides of an upper portion of the operating part and are provided with springs, and the upper end of each spring abuts against or is connected to the second extension part. The extension parts on the sliding plate facilitate stable sliding of the sliding plate and installation of the springs.

Furthermore, the connecting rod comprises a first connecting part, a step part and a second connecting part, wherein the first connecting part is located at the upper end of the connecting rod, the step part is located under the first connecting part, and the second connecting part is located under the step part; the second connecting part is provided with a first rectangular part extending in the front-back direction and a second rectangular part extending in the left-right direction; and a second through hole matched with the outer edge of the section of the second connecting part in shape is formed in the sliding plate. The connecting rod of such structure can be reliably connected with other components and is convenient to install. The connecting rod is matched with the sliding plate, so that dust and impurities are prevented from entering the shell from the outside.

Furthermore, a first hole matched with an outer edge of the lower portion of the connecting rod in shape is formed in the upper portion of the operating rod, or the operating rod and the connecting rod are integrally formed. The first hole facilitates inserted connection of the connecting rod. In other embodiment, the operating part and the connecting rod are integrally formed, so that the overall structure is firmer and more reliable.

Furthermore, the gear shifting device for electric cars further comprises a base detachably connected to the shell, and the first switch and the second switch are mounted on the base. The switches can be assembled more reliably through the base, and the overall structure is more compact.

Furthermore, a spring is connected to the lower end of the operating rod, a lower end of the spring abuts against or is connected to the steel ball, the steel ball abuts against the base, and positioning holes used for positioning the steel ball are formed in the base. The spring and the steel ball at the lower end of the operating rod facilitate smooth movement of the operating rod and improve the controllability.

The gear shifting device for electric cars is ingenious in structure, the operating part is located between the first switch and the second switch, the operating rod on the operating part can directly act on the switches to ingeniously control the switches to be located at the first positions or the second positions, the overall structure is compact and reasonable, and the service life is prolonged.

For a better understanding of the above and other objectives, characteristics and advantages of the invention, a detailed description is given below with reference to preferred embodiments and accompanying drawings.

### BRIEF DESCRIPTION OF THE SEVERAL VIEWS OF THE DRAWINGS

FIG. 1 is an exploded view of a gear shifting device for electric cars in embodiment 1 of the invention;

FIG. 2 is a structural view of a shell in embodiment 1 of the invention;

FIG. 3 is another structural view of the shell in embodiment 1 of the invention;

FIG. 4 is a structural view of a connecting rod in embodiment 1 of the invention;

FIG. 5 is a structural view of a sliding plate in embodiment 1 of the invention;

FIG. 6 is another structural view of the sliding plate in embodiment 1 of the invention;

FIG. 7 is a structural view of an operating part in embodiment 1 of the invention;

FIG. 8 is a structural view of a base in embodiment 1 of the invention;

FIG. 9 is a schematic diagram of the gear shifting device for electric cars at a high-speed forward gear in embodiment 1 of the invention, wherein FIG. 9-A is a structural view of the gear shifting device for electric cars at the high-speed forward gear, and FIG. 9-B is a bottom view of the gear shifting device for electric cars at the high-speed forward gear;

FIG. 10 is a schematic diagram of the gear shifting device for electric cars at a low-speed forward gear in embodiment 1 of the invention, wherein FIG. 10-A is a structural view of the gear shifting device for electric cars at the low-speed forward gear, and FIG. 10-B is a bottom view of the gear shifting device for electric cars at the low-speed forward gear;

FIG. 11 is a schematic diagram of the gear shifting device for electric cars at a low-speed reverse gear in one embodiment of the invention, wherein FIG. 11-A is a structural view of the gear shifting device for electric cars at the low-speed reverse gear, and FIG. 11-B is a bottom view of the gear shifting device for electric cars at the low-speed reverse gear;

FIG. 12 is another schematic diagram of the gear shifting device for electric cars at the high-speed forward gear in embodiment 1 of the invention, wherein FIG. 12-A is another structural view of the gear shifting device for electric cars at the high-speed forward gear, and 12-B is an A-A sectional view of the gear shifting device for electric cars at the high-speed forward gear;

FIG. 13 is another schematic diagram of the gear shifting device for electric cars at the low-speed forward gear in embodiment 1 of the invention, wherein FIG. 13-A is another structural view of the gear shifting device for electric cars at the low-speed forward gear, and FIG. 13-B is a B-B sectional view of the gear shifting device for electric cars at the low-speed forward gear;

FIG. 14 is another schematic diagram of the gear shifting device for electric cars at the low-speed reverse gear in embodiment 1 of the invention, wherein FIG. 14-A is another structural view of the gear shifting device for electric cars at the low-speed reverse gear, and FIG. 14-B is a C-C sectional view of the gear shifting device for electric cars at the low-speed reverse gear.

In the figures: 1, handle; 2, connecting rod; 3, shell; 4, sliding plate; 5, spring; 6, operating part; 7, steel ball; 8, switch; 9, base; 10, light switch; 21, first connecting part; 22, step part; 23, second connecting part; 30, convex part; 31, first through hole; 32, mounting part; 33, hook; 34, third through hole; 35, first mounting column; 41, second through hole; 42, curved surface; 61, first hole; 62, guide hole; 63, connecting column; 64, operating rod; 81, first switch; 82, second switch; 91, positioning hole; 92, second mounting column; 93, groove; 231, first rectangular part; 232, second rectangular part; 311, left through hole; 312, right through hole; 411, first rectangular hole; 412, second rectangular hole; 421, second extension part; 423, ribbed plate; 611, third rectangular hole; 612, fourth rectangular hole; 641, first reinforcing plate; 642, second reinforcing plate; 811, first control button; 821, second control button.

### DETAILED DESCRIPTION OF THE INVENTION

For a further illustration of the technical means adopted by the invention to fulfill the specific objective, the specific implementations, structures, characteristics and effects of the invention are expounded below with reference to the accompanying drawings and preferred embodiments.

It should be understood that directional or positional relations indicated by the terms such as ‘center’, ‘upper’, ‘lower’, ‘front’, ‘rear’, ‘left’, ‘right’, ‘top’, ‘bottom’, ‘inner’ and ‘outer’ mentioned in the following description of this application are directional or positional relations shown in the accompanying drawings, are only used for a brief description of this application, but do not indicate or imply that the devices or elements referred must have specific directions or must be assembled and operated in specific directions, thereby not being restrictive to this application.

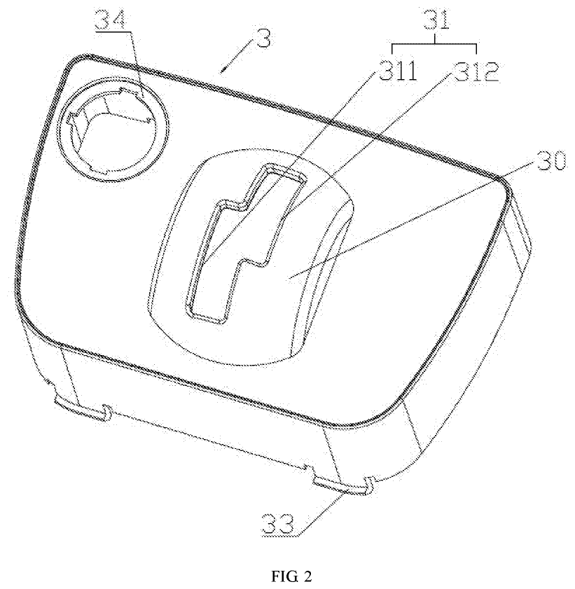

In this application, the advancing direction of electric cars is regarded as a forward direction, particularly, as for the shell in FIG. 2, the side away from observers is regarded as ‘front’, the side close to observers is regarded as ‘rear’, the left side of the shell is regarded as ‘left’, and the right side of the shell is regarded as ‘right’.

In addition, the terms ‘first’ and ‘second’ are only used for description and do not indicate or imply relative importance or the number of the technical characteristics indicated. Thus, characteristics defined by ‘first’ or ‘second’ can explicitly or impliedly include one or more such characteristics. Unless other clearly or specifically defined, ‘more than one’ means two or more in the description of this application.

In this application, unless other clearly or specifically defined, the terms ‘install’, ‘connect’, ‘connection’ and ‘fix’ should be comprehended in a broad sense, for instance, ‘connection’ may refer to ‘fixed connection’, ‘detachable connection’, ‘integral connection’, ‘mechanical connection’, ‘electrical connection’, ‘direct connection’, ‘indirect connection with intermediate medium’, or ‘internal communication of two elements’. Those ordinarily skilled in this field can comprehend specific meanings of these terms in this application in terms of specific conditions.

### Embodiment 1

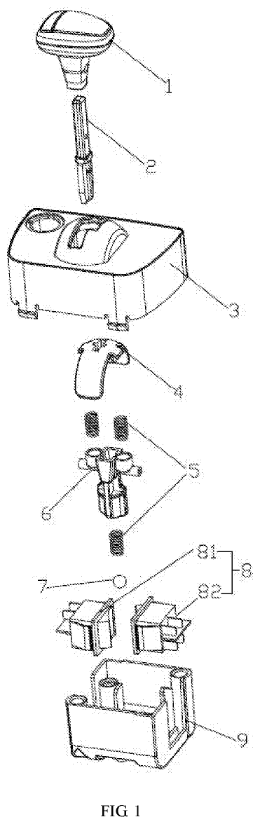

Referring to FIGS. 1-14, a gear shifting device for electric cars, as shown in FIG. 1, comprises a handle 1, a connecting rod 2, a shell 3, a sliding plate 4, springs 5, an operating part 6, a steel ball 7, two switches 8 and a base 9, wherein an upper end of the connecting rod 2 is inserted into the handle 1, a lower end of the connecting rod 2 penetrates through a first through hole 31 in the shell 3 and then penetrates through a second through hole 41 in the sliding plate 4 to be inserted into a first hole 61 in the middle of an upper end of the operating part 6, one spring 5 has an end abutting against a guide hole or a guide column at a lower end of the operating part 6 and an end abutting against the steel ball 7, a lower side of the steel ball 7 abuts against the base 9, and the two switches 8 are located on two sides of the operating part 6. When the operating part 6 is moved, a lower portion of the operating part 6 makes contact with the two switches 8, so that control buttons of the switches 8 are switched to a first position or a second position.

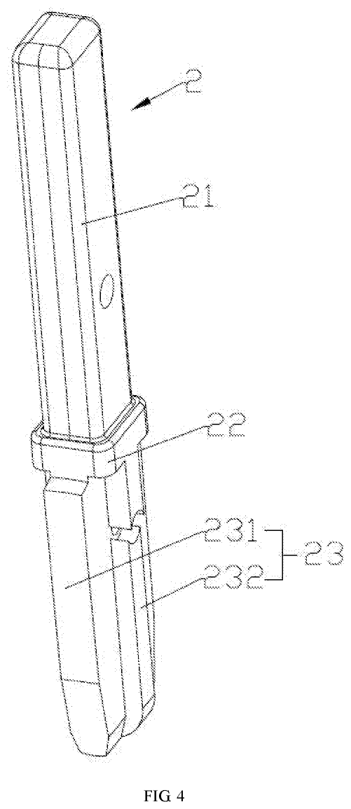

As shown in FIG. 4, the connecting rod 2 comprises a first connecting part 21, a step part 22 and a second connecting part 23, wherein the first connecting part 21 is located at the upper end of the connecting rod 2, the step part 22 is located under the first connecting part 21, the second connecting part 23 is located under the step part 22, the cross section of the first connecting part 21 and the cross section of the step part 22 are rectangular, and the sectional dimension of the step part 22 is greater than that of the first connecting part 21. The second connecting part 23 comprises a first rectangular part 231 extending in a front-back direction and a second rectangular part 232 extending in a left-right direction.

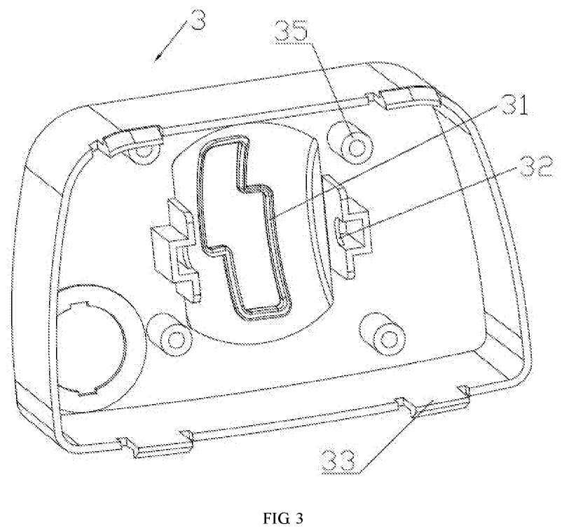

As shown in FIG. 2 and FIG. 3, a convex part 30 which protrudes upwards is arranged in the middle of an upper surface of the shell 3, wherein an outer surface of the convex part 30 is a curved surface, an inner surface of the convex part 30 is also a curved surface, and the section of each curved surface is in an arc shape. The first through hole 31 is formed in the convex part 30 and comprises a left through hole 311 and a right through hole 312, and the left through hole 311 is communicated with the right through hole 312. A third through hole 34 used for mounting a light switch 10 is formed in the shell 3 and is located on a left side of the convex part 30. Hooks 33 are arranged on a lower portion of the shell 3 and are used for detachably mounting the shell on an electric car. First mounting columns 35 are arranged on an inner surface of the shell 3, mounting parts 32 are arranged on the inner surface of the shell 3 and are located on two sides of the convex part, and connecting columns 63 rotatably arranged on the operating part 6 are rotatably mounted on the mounting parts 32.

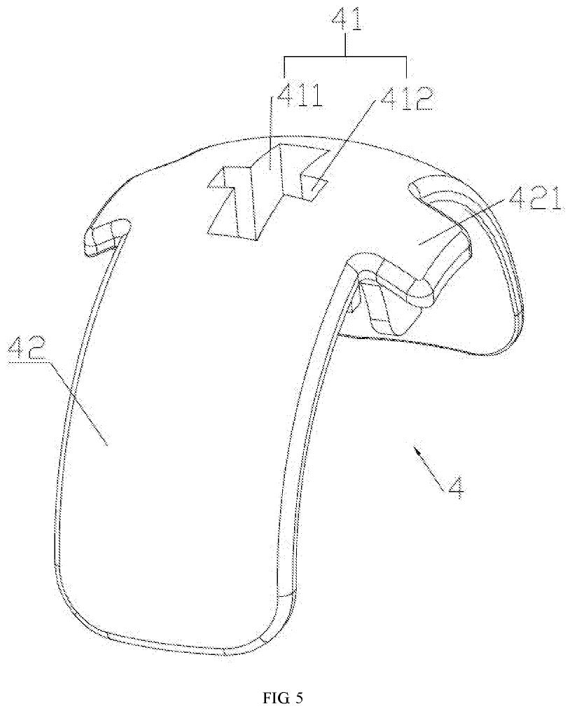

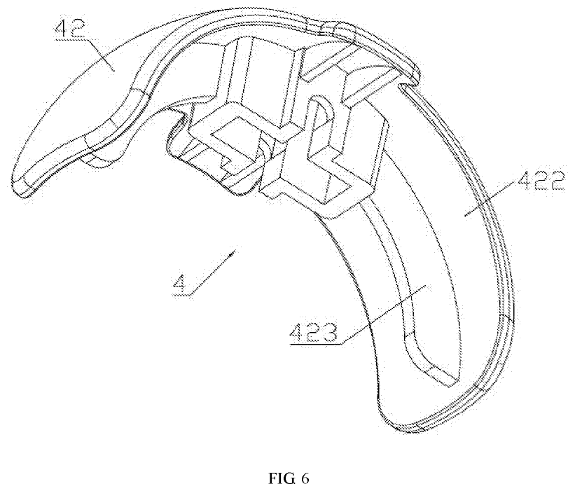

As shown in FIG. 5 and FIG. 6, an upper surface of the sliding plate 4 is a curved surface 42, and the curved surface 42 is provided with a first extension part extending in the front-back direction and a second extension part 421 extending in the left-right direction. The second through hole 41 is formed in the middle of the sliding plate 4 and comprises a first rectangular hole 411 extending in the front-back direction and a second rectangular hole 412 extending in the left-right direction. A ribbed plate 423 is arranged on a lower surface of the sliding plate 4.

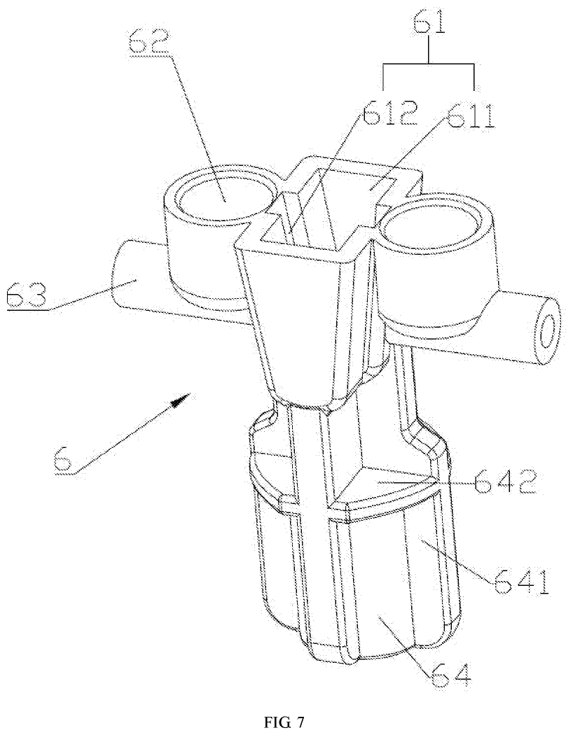

As shown in FIG. 7, the first hole 61 which is concaved downwards is formed in the middle of the upper end of the operating part 6 and comprises a third rectangular hole 611 extending in the front-back direction and a fourth rectangular hole 612 extending in the left-right direction. The cross-sectional dimension of the first hole 61 is gradually decreased from top to bottom. Guide holes 62 or guide columns used for mounting the corresponding springs 5 are arranged on two sides of the first hole 61. The connecting columns 63 are located below the two guide holes 62. An operating rod 64 is arranged at the lower end of the operating part 6 and is provided with first reinforcing plates 641 which protrude forwards, backwards, leftwards and rightwards. The first reinforcing plates 641 are connected through second reinforcing plates 642.

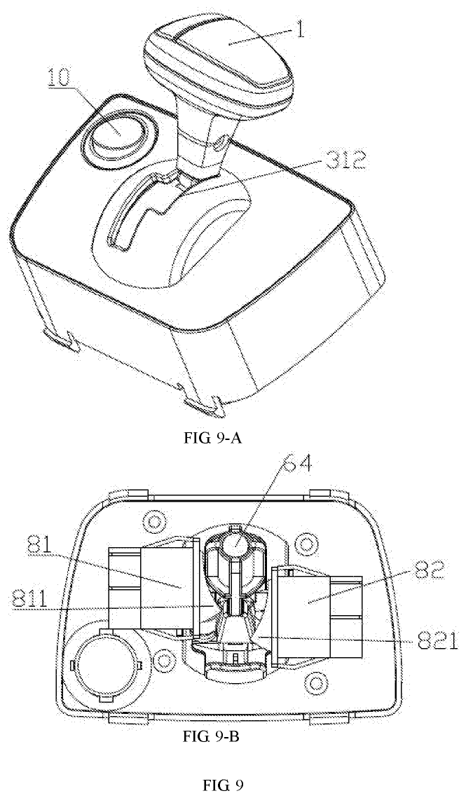

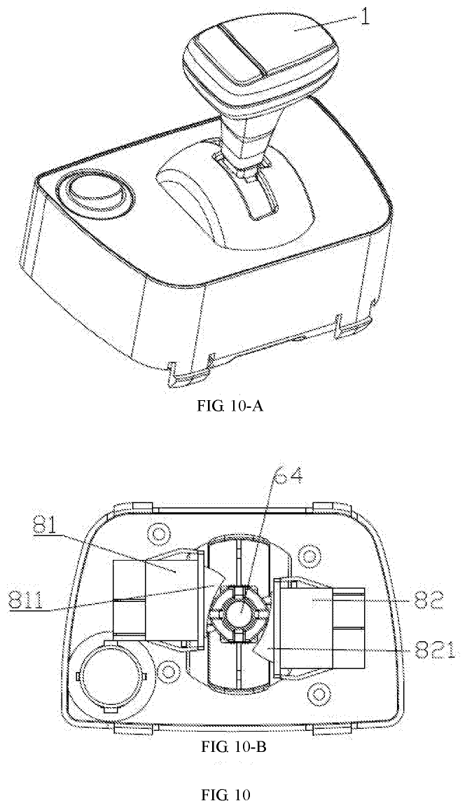

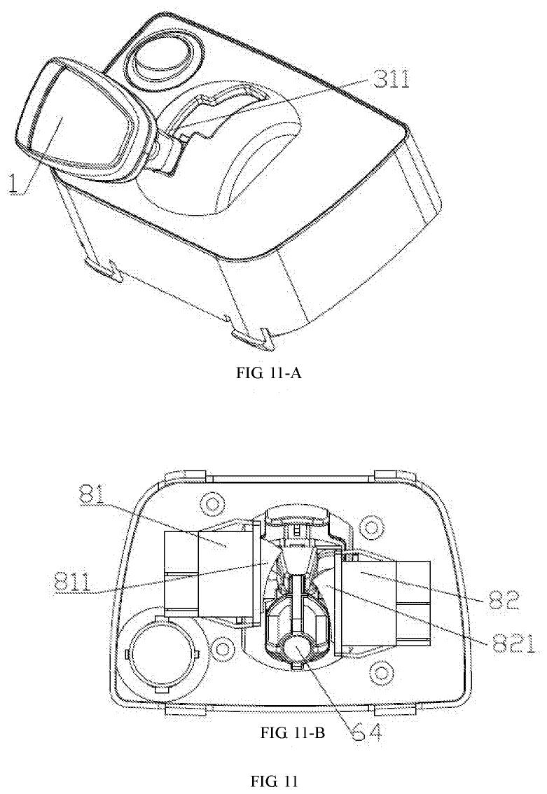

As shown in FIG. 1, FIG. 9, FIG. 10 and FIG. 11, the switches 8 include a first switch 81 and a second switch 82. The first switch 81 is used for switching between a high speed and a low speed, particularly, a first position where a first control button 811 of the first switch 81 is located is a high-speed gear position, and a second position where the first control button 811 is located is a low-speed gear position. The second switch 82 is used for switching between advancing and reversing, particularly, a first position where a second control button 821 of the second switch 82 is located is a forward-gear position, and a second position where the second control button 821 is located is a reverse-gear position.

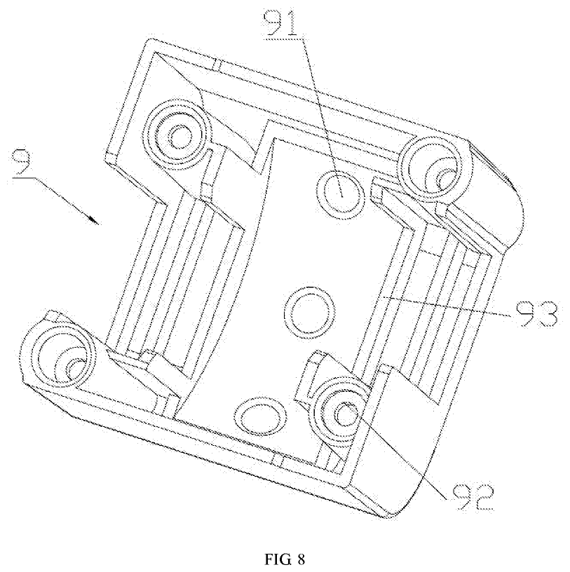

As shown in FIG. 8, positioning holes 91 which are concaved downwards are formed in the base 9, second mounting columns 92 matched with the first mounting columns 35 are arranged at four corners of the base 9, and grooves 93 used for mounting the switches 8 are formed in two sides of the base 9.

When assembled, the connecting rod 2 penetrates through the first through hole 31, the first rectangular part 231 at the lower end of the connecting rod 2 is clamped in the first rectangular hole 411 of the sliding plate 4 in a matched manner, the second rectangular part 232 is clamped in the second rectangular hole 412 of the sliding plate 4 in a matched manner, the lower surface of the step part 22 abuts against the curved surface 42, the upper end of the connecting rod 2 is inserted into the handle 1, and the upper surface of the step part abuts against the handle 1. The lower end of the connecting rod 2 is inserted into the first hole 61 of the operating part 6, the first rectangular part 231 is clamped in the third rectangular hole 611 in a matched manner, and the second rectangular part 232 is clamped in the fourth rectangular hole 612 in a matched manner.

The upper surface of the sliding plate 4 makes contact with the inner surface of the convex part 30 on the shell 3, the upper end of one spring 5 abuts against or is connected to the second extension part 421 of the sliding plate 4, and the lower end of the spring 5 abuts against or is connected into the corresponding guide hole 62 of the operating part 6. The connecting columns 63 on the left side and the right side of the operating part 6 are rotatably connected into the mounting parts 32.

The upper end of the other spring 5 abuts against or is connected into the corresponding guide hole or guide column at the lower end of the operating rod 64, and the other end of the spring 5 abuts against the steel ball 7, the other side of the steel ball 7 abuts against the base 9, and the two switches 8 are mounted in the grooves 93 and are located on two sides of the operating rod 64. When seen from the top, the first switch 81 is located at a rear left position, and the second switch 82 is located at a front right position. The first mounting columns 35 are aligned to the second mounting columns 92 and are fixedly connected with the second mounting columns 92 with fasteners (such as screws).

When mounted in electric cars, the gear shifting device for electric cars has the following three modes in use:

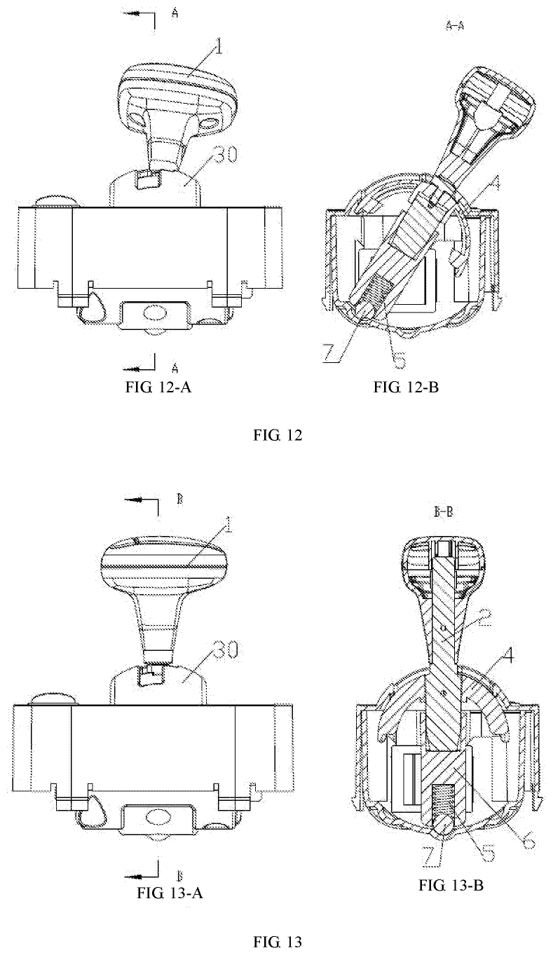

(1) High-speed advancing mode: As shown in FIG. 9 and FIG. 12, when the handle 1 is pushed forwards and rightwards, the connecting rod 2 drives the operating part 6 to rotate around the connecting columns 63 and is located at a front position of the right through hole 312, the left side of the operating rod 64 acts on the first control button 811 of the first switch 81 to move the first control button 811 to the first position, the steel ball 7 at the lower end of the operating rod 64 is located in the positioning hole 91 in the rear portion of the base 9, and the electric car advances at a high speed when operators tread on an accelerator pedal of the electric car by feet.

(2) Low-speed advancing mode: As shown in FIG. 10 and FIG. 13, when the handle 1 is pushed backwards, the operating rod 2 drives the operating part 6 to rotate around the connecting columns 63 and is located at a rear position of the right through hole 312, the left side of the operating rod 64 acts on the first control button 811 of the first switch 81 to move the first control button 811 to the second position from the first position, the steel ball 7 at the lower end of the operating rod 64 is located in the positioning hole 91 in the middle of the base 9, and the electric car advantages at a low speed when the operators tread on the accelerator pedal of the electric car by feet.

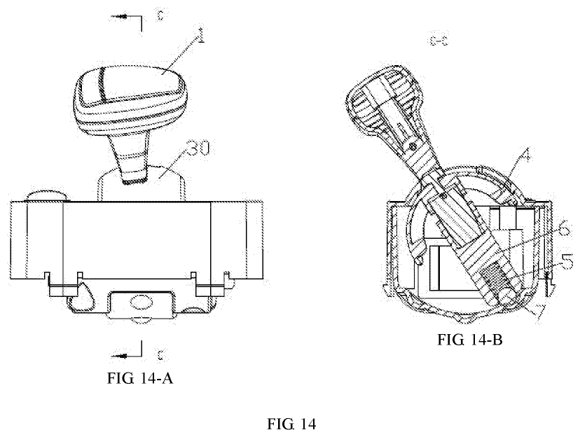

(3) Low-speed reversing mode: As shown in FIG. 11 and FIG. 14, when the handle 1 is pushed backwards and leftwards, the connecting rod 2 drives the operating part 6 to rotate around the connecting columns 63 and moves into the left through hole 311 from the right through hole 312, the right side of the operating rod 64 acts on the second control button 821 of the second switch 82 to move the second control button 821 to the second position from the first position, the first control button 811 is also located at the second position at this moment, the steel ball 7 at the lower end of the operating rod 64 is located in the positioning hole 91 in the front portion of the base 9, and the electric car reverses at a low speed when the operators tread on the accelerator pedal of the electric car by feet. In the low-speed reversing mode, the electric car reverses at a low speed instead of a high speed when used by the operators, and thus, the safety performance is improved.

### Embodiment 2

In this embodiment, when seen from the top, the first switch is located at a front left position, and the second switch is located at a rear right position. The operating rod is located between the first control button of the first switch and the second control button of the second switch; in this case, the second control button of the second switch is used for switching between a high speed and a lower speed, particularly, a first position where the second control button is located is a high-speed gear position, and a second position where the second control button is located is a low-speed gear position; and the first switch is used for switching between advancing and reversing, particularly, a first position where the first control button of the first switch is located is a forward-gear position, and a second position where the first control button is located is a reverse-gear position. Other structure and principles of embodiment 2 are identical with those of embodiment 1 and thus will not be detailed anymore.

The above embodiments are only preferred ones of the invention and are not intended to limit the invention in any forms. Based on the preferred embodiments disclosed above, any skilled in this field can obtain equivalent embodiments by slightly changing or modifying the above technical contents without deviating from the technical solution of the invention, and all these simple amendments, equivalent changes and modifications achieved based on the technical essence without deviating from the technical solution of the invention should also fall within the scope of the technical solution of the invention.

What is claimed is:

1. A gear shifting device for electric cars, comprising a shell (3), a first switch (81), a second switch (82) and an operating part (6), wherein a first control button (811) of the first switch (81) and a second control button (821) of the second switch (82) are oppositely arranged, an upper portion of the operating part (6) is rotatably connected to the shell (3), an operating rod (64) is arranged on a lower portion of the operating part (6), the operating rod (64) is located between the first control button (811) and the second control button (821) and is able to move back and forth in a front-back direction, the first control button (811) is located on a left side of the front-back moving direction of the operating rod (64), the second control button (821) is located on a right side of the front-back moving direction of the operating rod (64), the operating rod (64) is able to contact the first control button (811) to switch the first control button (811) to a first position or a second position, and the operating rod (64) is also able to contact the second control button (821) to switch the second control button (821) to a first position or a second position.

2. The gear shifting device for electric cars according to claim 1, wherein connecting columns (63) to be rotatably connected to the shell (3) are arranged on two sides of the upper portion of the operating rod (6).

3. The gear shifting device for electric cars according to claim 1, wherein the operating rod (64) is provided with first reinforcing plates (641) protruding forwards, backwards, leftwards and rightwards, and the first reinforcing plates (641) are connected through second reinforcing plates (642).

4. The gear shifting device for electric cars according to claim 1, wherein a connecting rod (2) is connected to the upper portion of the operating part (6), an upper end of the connecting rod (2) stretches out of the shell (3) and is connected with a handle (1), and a first through hole (31) allowing the connecting rod (2) to move forwards or backwards is formed in the shell (3).

5. The gear shifting device for electric cars according to claim 4, wherein a sliding plate (4) is arranged around the connecting rod (2), an upper surface of the sliding plate (4) is an arc-shaped curved surface, a convex part (30) which protrudes upwards is arranged in a middle of the shell (3), an inner surface of the convex part (30) is an arc-shaped curved surface, and the upper surface of the sliding plate (4) abuts against the inner surface of the convex part (30).

6. The gear shifting device for electric cars according to claim 5, wherein the sliding plate (4) is provided with a first extension part extending in the front-back direction and a second extension part (421) extending in the left-right direction, guide holes (62) or guide columns are arranged on a left side and a right side of the upper portion of the operating part (6) and are provided with springs (5), and upper ends of the springs (5) abut against or are connected to the second extension part.

7. The gear shifting device for electric cars according to claim 5, wherein the connecting rod (2) comprises a first connecting part (21), a step part (22) and a second connecting part (23), the first connecting part (21) is located at an upper end of the connecting rod (2), the step part (22) is located under the first connecting part (21), and the second connecting part (23) is located under the step part (22); the second connecting part (23) is provided with a first rectangular part (231) extending in the front-back direction and a second rectangular part (232) extending in the left-right direction; and a second through hole (41) matched with an outer edge of a section of the second connecting part (23) in shape is formed in the sliding plate (4).

8. The gear shifting device for electric cars according to claim 4, wherein a first hole (61) matched with an outer edge of a lower portion of the connecting rod (2) in shape is formed in the upper portion of the operating part (6); or, the operating part (6) and the connecting rod (2) are integrally formed.

9. The gear shifting device for electric cars according to claim 1, wherein the gear shifting device further comprises a base (9) detachably connected to the shell (3), and the first switch (81) and the second switch (82) are mounted on the base (9).

10. The gear shifting device for electric cars according to claim 9, wherein a spring (5) is connected to a lower end of the operating rod (64), a lower end of the spring (5) abuts against or is connected to a steel ball (7), the steel ball (7) abuts against the base (9), and positioning holes (9) used for positioning the steel ball (7) are formed in the base (9).
